(19) United States
(12) Patent Application Publication
(10) Pub. No.: US 2021/0080063 A1
(43) Pub. Date: Mar. 18, 2021

(54) HORIZONTALLY WELDED LED FILAMENT LAMP BULB

(71) Applicant: Dongguan Yicheng Lighting Tech Co.,Ltd., Dongguan (CN)

(72) Inventor: Jianwen Lei, Dongguan (CN)

(21) Appl. No.: 16/596,132

(22) Filed: Oct. 8, 2019

(30) Foreign Application Priority Data
Sep. 18, 2019 (CN) 201921550230.X

(51) Int. Cl. F21K 9/232; F21K 9/238; F21K 9/66

(52) U.S. Cl. CPC F21K 9/232; F21K 9/66; F21K 9/238

(57) ABSTRACT

A flat-welded LED filament lamp bulb comprises an LED filament, a core column, a lamp shade and a lamp cap. The core column protrudes into the lamp shade, an end of the core column is disposed with a flare opening, and the flare opening and a lamp shade opening of the lamp shade are sintered and sealed into a lamp body. A core column exhaust tube is disposed in the middle of the core column. A first conductive wire and a second conductive wire are disposed in parallel on the core column. One resistor or a drive element for driving LED is disposed on the first conductive wire or the second conductive wire. The LED filament is fixedly welded between tops of the first conductive wire and the second conductive wire horizontally. The visual brightness of the lamp bulb is increased, better illumination effect is provided to different angles.

### CROSS-REFERENCES TO RELATED APPLICATIONS

This application claims priority from Chinese Patent Application No. 201921550230.X filed Sep. 18, 2019, the entire content of which is incorporated herein as reference.

### BACKGROUND OF THE INVENTION

### 1. Technical Field

The present application relates to the field of LED lamp bulb technology, in particular to a flat-welded LED filament lamp bulb.

### 2. Background Art

An existing LED filament lamp bulb usually adopts a straight-strip filament and an edge of a support of the straight-strip filament is in a straight-line state. Therefore, the straight-strip filament is often assembled into the lamp bulb linearly or slightly obliquely. Due to unique light distribution curve of each filament, illuminances on both sides of the lamp bulb will be very high after reflection or refraction of fluorescent powder, and illuminance of bottom will be very low. In this case, a light emitting angle of the lamp bulb will be limited to some extent.

### SUMMARY OF THE INVENTION

The present application provides a flat-welded LED filament lamp bulb for the existing technical problems.

To solve the above technical problems, the present application adopts the following solution.

A flat-welded LED filament lamp bulb is provided, including an LED filament, a core column, a lamp shade and a lamp cap. The core column protrudes into the lamp shade, an end of the core column disposed with a flare opening, and the flare opening and a lamp shade opening of the lamp shade are sintered and sealed into one lamp body. Further, a core column exhaust tube is disposed in the middle of the core column so that a gas for extending a service life is injected after vacuumization is performed with the exhaust tube. A first conductive wire and a second conductive wire are disposed in parallel in the core column. The first conductive wire or the second conductive wire is disposed with a resistor or a drive element for driving LED. The LED filament is fixedly welded between tops of the first conductive wire and the second conductive wire horizontally so that the core column becomes the one containing its own resistor or drive element.

Lengths that the first conductive wire and the second conductive wire protrude out of the core column are same, and the first conductive wire and the second conductive wire are inclined sideways by a given angle respectively or inclined to form a V shape.

Preferably, the LED filament is an all-angle luminous filament which is in a straight-line shape or an arc shape.

The resistor or the drive element is disposed at a middle portion or a lower portion of the first conductive wire or the second conductive wire and located at an inner side of the core column.

The present application has the following beneficial effects.

The present application provides a flat-welded LED filament lamp bulb. The visual brightness of the lamp bulb may be increased by fixedly welding an LED filament between the tops of the first conductive wire and the second conductive wire of the core column horizontally. The light efficiency of the LED filament faces the top of the lamp shade, therefore, better illumination effect can be provided to different angles. Compared with the existing LED lamp bulb, this lamp bulb has an effect close to that of an incandescent lamp. Therefore, it is more applicable to automatic production. Through automatic welding and assembly, labor costs are greatly reduced, and product quality is improved.

### BRIEF DESCRIPTION OF THE DRAWINGS

FIG. 1 is a schematic diagram illustrating a structure of a core column in the present application.

FIG. 2 a schematic diagram illustrating a structure of a lamp core in present the present application.

FIG. 3 is a schematic diagram illustrating a structure of an unfinished lamp bulb in the present application.

FIG. 4 is a schematic diagram illustrating a structure of a flat-welded LED filament lamp bulb in the present application.

### DETAILED DESCRIPTION OF PREFERRED EMBODIMENTS OF THE INVENTION

To help those skilled in the art to understand the present application, the present application will be further detailed below in combination with examples and accompanying drawings. Contents mentioned in the examples are not intended to limit the present application. The present application is detailed below in combination with the accompanying drawings.

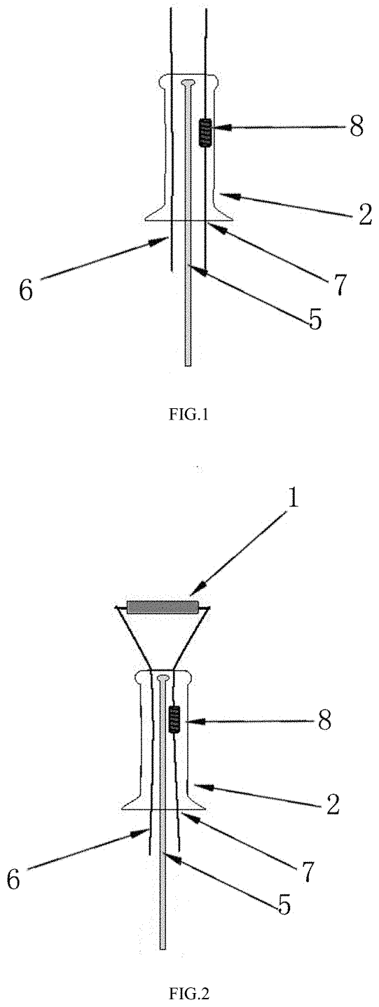

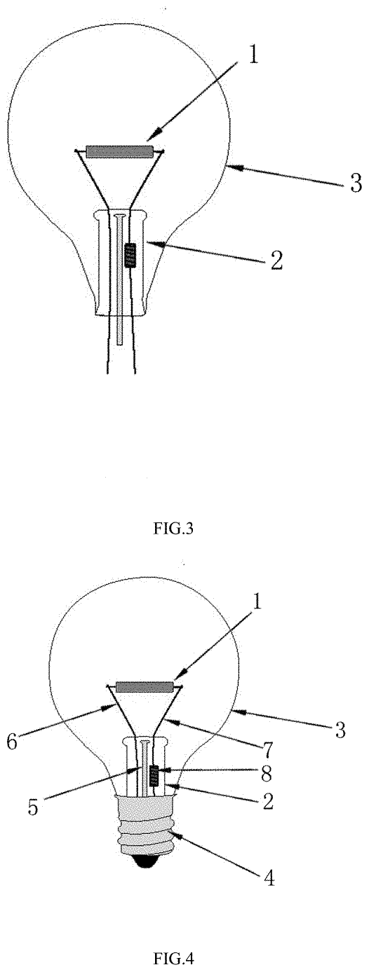

In the FIGS. 1-4, the numerals are described as follows:

1 refers to an LED filament, 2 refers to a core column, 3 refers to a lamp shade, 4 refers to a lamp cap, 5 refers to a core column exhaust tube, 6 refers to a first conductive wire, 7 refers to a second conductive wire, and 8 refers to a resistor or a drive element.

A flat-welded LED filament lamp bulb according to the present application includes an LED filament 1, a core column 2, a lamp shade 3 and a lamp cap 4. The core column 2 protrudes into the lamp shade 3, an end of the core column 2 is disposed with a flare opening, and the flare opening and a lamp shade opening of the lamp shade 3 are sintered and sealed into a lamp body. Further, a core column exhaust tube 5 is disposed in the middle of the core column 2 so that a gas for extending a service life is injected after vacuumizing is performed with the exhaust tube. This gas is an inert gas for protecting the LED filament and extending its service life. A first conductive filament 6 and a second conductive filament 7 are disposed in parallel in the core column 2. A resistor or a drive element 8 for driving LED is disposed on the first conductive filament 6 or the second conductive filament 7. In this example, the resistor or the drive element 8 is disposed on the second conductive filament 7. Further, the second conductive filament 7 is used as a positive pole of the lamp bulb. The LED filament 1 is fixedly welded between tops of the first conductive filament 6 and the second conductive filament 7 horizontally so that the core column becomes the one containing the resistor or the drive element. In the present application, the visual brightness of the lamp bulb may be increased by fixedly welding the LED filament 1 between the tops of the first conductive wire 6 and the second conductive wire 7 of the core column 2 horizontally. The light efficiency of the LED filament faces the top of the lamp shade, and, therefore, better illumination effect can be provided to different angles. Compared with the existing LED lamp bulb, this lamp bulb has an effect close to that of an incandescent lamp. Therefore, it is more applicable to automatic production. Through automatic welding and assembly, labor costs are greatly reduced, and product quality is improved.

In the present application, as shown in FIGS. 1 and 2, lengths that the first conductive filament 6 and the second conductive filament 7 protrude out of the core column 2 are same, and the first conductive filament 6 and the second conductive filament are inclined sideways by a given angle respectively or inclined to form a V shape. In this case, both ends of the LED filament 1 are exactly contact-welded with the first conductive wire 6 and the second conductive wire 7.

Preferably, the LED filament 1 is an all-angle luminous filament which is in a straight-line shape or an arc shape. In the example, the LED filament 1 is in the straight-line shape.

In the present application, the resistor or the drive element 8 is disposed at a middle portion or a lower portion of the first conductive wire 6 or the second conductive wire 7 and located at an inner side of the core column 2. The resistor or the drive element 8 is hidden inside the core column 2 so that the resistor or the drive element 8 will not affect the aesthetics of the LED lamp bulb.

The above descriptions are merely preferred examples of the present application and not intended to limit to the present application in any form. Although the present application is disclosed through the preferred examples as above, the preferred examples are not intended to limit the present application. Any changes or modifications made by those skilled in the art based on the above disclosed technical contents without departing from the scope of the technical solutions of the present application shall be regarded as equivalent examples with equivalent changes. Any simple changes, equivalent changes or modifications made to the above examples by those skilled in the art based on the technology of the present application without departing from the scope of the technical solutions of the present application shall all fall within the scope of the technical solutions of the present application.

1. A LED filament lamp bulb, comprising an LED filament, a core column, a lamp shade, and a lamp cap, wherein the core column protrudes into the lamp shade, an end of the core column is disposed with a flare opening, the flare opening and a lamp shade opening of the lamp shade are integrated into an integral form, a core column exhaust tube is disposed in the middle of the core column, a first conductive wire and a second conductive wire are disposed in parallel at least partially in the core column, at least one resistor for driving LED is disposed on the first conductive wire or the second conductive wire inside the core column and at approximately middle of the core column, the LED filament is connected between tops of the first conductive wire and the second conductive wire horizontally so that the core column contains the resistor, and the LED filament is an all-angle luminous filament in a straight-line shape or an arch shape.

2. The LED filament lamp bulb according to claim 1, wherein lengths that the first conductive wire and the second conductive wire protrude out of the core column are the same, and the first conductive wire and the second conductive wire are inclined sideways by a given angle respectively or inclined to form a V shape.

3. The LED filament lamp bulb according to claim 1, wherein the LED filament is an all-angle luminous filament which is in a straight-line shape.

4. The LED filament lamp bulb according to claim 1, wherein the resistor is disposed at a middle portion or a lower portion of the first conductive wire or the second conductive wire.
